(19) United States
(12) Patent Application Publication
(10) Pub. No.: US 2003/0093303 A1
(43) Pub. Date: May 15, 2003

(54) System, apparatus, and method for implementing a retirement plan for a cooperative and members thereof

(75) Inventor: Dana A. Pooler, Afton, NY (US)

Correspondence Address: Gary B. Solomon, Esq., Jenkens & Gilchrist, P.C., 3200 Fountain Place, 1445 Ross Avenue, Dallas, TX, 75202-2799, US

(73) Assignee: MANG ADVISORS, LLC.

(21) Appl. No.: 10/205,123

(22) Filed: Jul. 24, 2002

Related U.S. Application Data
(60) Provisional application No. 60/307,621, filed on Jul. 24, 2001.

(51) Int. Cl. G06F 17/60

(52) U.S. Cl. 705/4

(57) ABSTRACT

A system and method for providing a retirement savings plan for members of a cooperative. The method includes receiving produce from a member of the cooperative. A revenue based on the produce received from the member. An elected deferral based on the revenue may be established by the member. A matching contribution based on the elected deferral may be distributed to an escrow account associated with the member, where a vesting schedule may be applied to the matching contribution in the escrow account. In a profitable year for the member, the elected deferral and vested matching contribution may be applied to a qualified plan. Otherwise, the elected deferral and vested matching contribution may be applied to a non-qualified plan. In one embodiment, the cooperative is a dairy cooperative and the member is a producer of dairy products, such as milk.

### CROSS-REFERENCES TO RELATED APPLICATIONS

This Application for Patent claims the benefit of and priority from co-pending U.S. Provisional Application for Patent Serial No. 60/307,621, filed Jul. 24, 2001, and hereby incorporates by reference, the entire disclosure thereof.

### BACKGROUND OF THE PRESENT INVENTION

1. Field of the Invention

The principles of the present invention generally relate to retirement planning, and more particularly, but not by way of limitation, to a method and system for a dairy cooperative to provide a retirement planning program for members thereof.

2. Background of the Invention

The dairy industry is fairly unique within the agricultural industry in that its primary goods are highly perishable products. The perishable nature of the goods is ultimately a costly reality for the dairy industry. One reason for high costs includes processing of the highly perishable product since specialized equipment is needed. Consequently, such specialized equipment typically demands a large, fixed investment on behalf of a dairy, which is generally cost prohibitive for an individual farm.

To address some of the unique challenges facing the dairy industry, dairy farmers formed cooperatives. Indeed, dairy farmers were one of the first agricultural groups to implement cooperatives as a mechanism to produce, market and/or distribute their products. By individual dairy farms being a member of the cooperative, the members are able to defray the fixed costs that had previously been the burden of each dairy farm. In other words, the cooperative spreads the fixed costs among many members rather than each member bearing the burden of the costly equipment. Dairy cooperatives also offer members other benefits, including: guaranteed markets, efficiency in marketing, collective price terms, and representation on a macro level in many national arenas. Discounts in the cost of farm supplies and services are also available to the members of the dairy cooperative. However, membership benefits and costs vary among the cooperatives.

Dairy cooperatives are generally classified as either a bargaining-only cooperative or a manufacturing/processing cooperative. As the name implies, bargaining-only cooperatives contract for the sale price of their members' product and terms of trade. Manufacturing/processing cooperatives may bargain and negotiate on behalf of their members, as well as manufacture and/or process their members' product in the cooperative's facilities. Dairy farmer membership in a cooperative is voluntary and conducted through membership agreements. Dairy cooperatives are financed largely through their members, so retention of members is important for the survival of the cooperative. As the type of cooperative differs, so does the way in which the cooperative is financed. Some cooperatives, such as the bargaining-only cooperatives, charge marketing service fees to their members. Others automatically deduct a per-unit fee or charge, typically a charge per hundredweight (CWT), from milk payments to the members. Still other cooperatives have each member contribute a fixed amount of capital based on past milk production.

Despite the formation of cooperatives, the number of dairy farmers has declined almost eighty percent since the 1930s. Accordingly, the number of cooperatives has also declined during this time period. One reason for the decline in both dairy farmers and dairy cooperatives may be attributed to merger and consolidation activities within the industry in order to retain profitability. Many factors still affect the continued viability of the dairy producer. First, a dairy farm may be affected by regional shifts of production, foreign trade agreements, and technological advances within the industry. Second, volume produced of dairy products generally varies with the season, not with demand. Because of the highly perishable nature of the dairy products, dairy farms cannot over-produce in one season to make up for a lower volume of product in previous seasons. Finally, dairy products are a commodity subject to regulation and volatile market prices. Due to these factors, among others, dairy producers have little stability from year to year as to whether or not the dairy will make a profit. As a result, many dairy farmers find it difficult to adequately plan for retirement.

Under the Internal Revenue Code of 1986 as amended (the “Code”), each dairy farm is considered an individual business operating unit. Syndicate organizations having a relationship with members who are not employees (“non-employees”) including, without limitation, farm cooperatives under Section 501(c)(16) of the Code; business leagues, chambers of commerce, and other organizations under Section 501(c) (6) of the Code; cemetery companies under Section 501(c)(13) of the Code; and credit unions without capital stock under Section 501(c)(14) of the Code, for example.

The dairy farm has traditionally been considered an independent contractor in relation to the dairy cooperative. As an independent contractor, the dairy farm has been unable to participate in traditional group retirement savings plans, such as 401(k) plan, profit sharing plan, and/or pension plan, through the cooperative because, under the tax code, these plans have been enacted for the benefit of employees, not independent contractors. The burden of seeking out information on available retirement savings plans for individual, self-employed independent contractors, such as a KEOGH plan, and the cost associated with implementing such a plan was placed solely on the individual dairy producers with no help from an entity similar to an employer.

In the past, cooperatives have been able to offer various group benefit packages to its members, but have been unable to include a vehicle for retirement planning because of the lack of an employer/employee (wage based) relationship with the members. In instances when a member (e.g., farmer) might have elected to utilize an existing retirement planning vehicle, it was difficult to do so consistently on a year-to-year basis due to the fact that farm profits often vary dramatically from year-to-year. Because funding a tax-qualified plan is limited to profits, for the self-employed, many farmers are prevented from addressing their retirement planning needs. The ability for a cooperative to offer a benefits package benefits the individual member of the cooperative and fosters goodwill, loyalty, and commitment on behalf of the cooperative to enhance the retention of its members. Therefore, it is desirable for both the individual members and the cooperative to be able to offer members a group retirement savings plan that offers contribution flexibility—irrespective of profitability of the member on an individual year basis.

### SUMMARY OF THE INVENTION

To provide for a group retirement savings plan that offers contribution flexibility irrespective of profitability of the member on an individual year basis, a group retirement savings program has been developed that provides members of a cooperative the ability to establish an elected deferral (i.e., contribute money) to the retirement savings plan each year—irrespective of the profitability of the member for the year. The cooperative may offer a matching contribution to further encourage the members to maintain the elected deferral. And, by the cooperative providing a matching contribution, the members are able to financially benefit even though they may not be able to show a profit for the year. In non-profitable or minimally profitable years, the member may apply the elected deferral and matching contribution, which may be subject to a vesting schedule, to non-qualified programs or investment options. In a profitable year, the members may apply the elected deferral and matching contribution to qualified plan options.

More particularly, the principles of the present invention provide for a system and method for providing a retirement savings plan for members of a cooperative as defined under Section 501(c) of the Code. The method includes receiving produce from a member of the cooperative. A revenue stream based on the produce received from the member and a matching contribution based on that revenue stream may be determined. The matching contribution may be distributed to an escrow account associated with the member. In one embodiment, the cooperative is a dairy cooperative and the member is a producer of dairy products, such as milk.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a block diagram illustrative of relationships between parties associated with a cooperative, where the parties include members of the cooperative and financial institution(s) that provide retirement savings plans to the members according to the principles of the present invention;

FIG. 2 illustrates an exemplary system network including databases for maintaining information associated with the parties of FIG. 1;

FIG. 3 is an exemplary flow diagram describing a process for determination and distribution of matching contribution for the members of the cooperative of FIG. 1;

FIG. 4 is an exemplary flow diagram describing a process for receiving and maintaining savings revenue, including the matching contribution, in an account for the members of the cooperative of FIG. 1; and

FIG. 5 is an exemplary flow diagram describing a process for providing a retirement savings plan to the members of the cooperative of FIG. 1.

### DETAILED DESCRIPTION OF THE DRAWINGS

The principals of the present invention provide for a cooperative to offer its members the ability to participate in a traditional group administered retirement savings plan. Group retirement savings plan benefits may be provided to encourage members to participate in the retirement savings plan. For example, the cooperative may offer systematic elected deferrals and matching contributions based on the elected deferrals to its members. The systematic elected deferrals may include periodic (e.g., monthly) or non-periodic (e.g., dates of receipt of product) deposits to a general holding account associated with the retirement savings plan. To overcome the problem of members not being able to take advantage of retirement savings plans in non-profitable years so as to receive the benefit of the matching contribution offered by the cooperative, the general holding account and an escrow account may be established. The elected deferral monies may be applied to the general holding account and the matching funds based on revenue produced and/or elected deferral monies may be applied to the escrow account. The escrow account may be managed by the cooperative or by an independent financial advisor. A vesting schedule also may be applied to the matching contribution in the escrow account to allow the members to have access to the matching funds or portions thereof at predetermined time schedules.

The monies in the general holding account may be applied to a number of investment or operation vehicles (e.g., equipment, cattle feed). In a year that the member shows a profit, the monies may be applied to a qualified plan to reduce tax exposure for the member according to the tax code for the particular qualified financial vehicle selected. In a year that the member does not show a profit or a limited profit (as defined by the tax code), the monies in the general holding account may be applied to non-qualified programs (e.g., insurance) or investments.

Once the matching funds in the escrow account have vested for a member, those vested matching funds may be utilized by the member to invest in a qualified plan (e.g., 401K plan) in a profitable year, non-qualified plan (e.g., health insurance, life insurance, and various non-qualified investments) in a non-profitable year, or to purchase operational supplies. The matching funds from the cooperative creates an incentive for the member to participate in the savings process regardless of profitability. The qualified and non-qualified plans may be managed by a financial institution and allow for traditional financial investments, such as stocks, bonds, mutual funds and annuities.

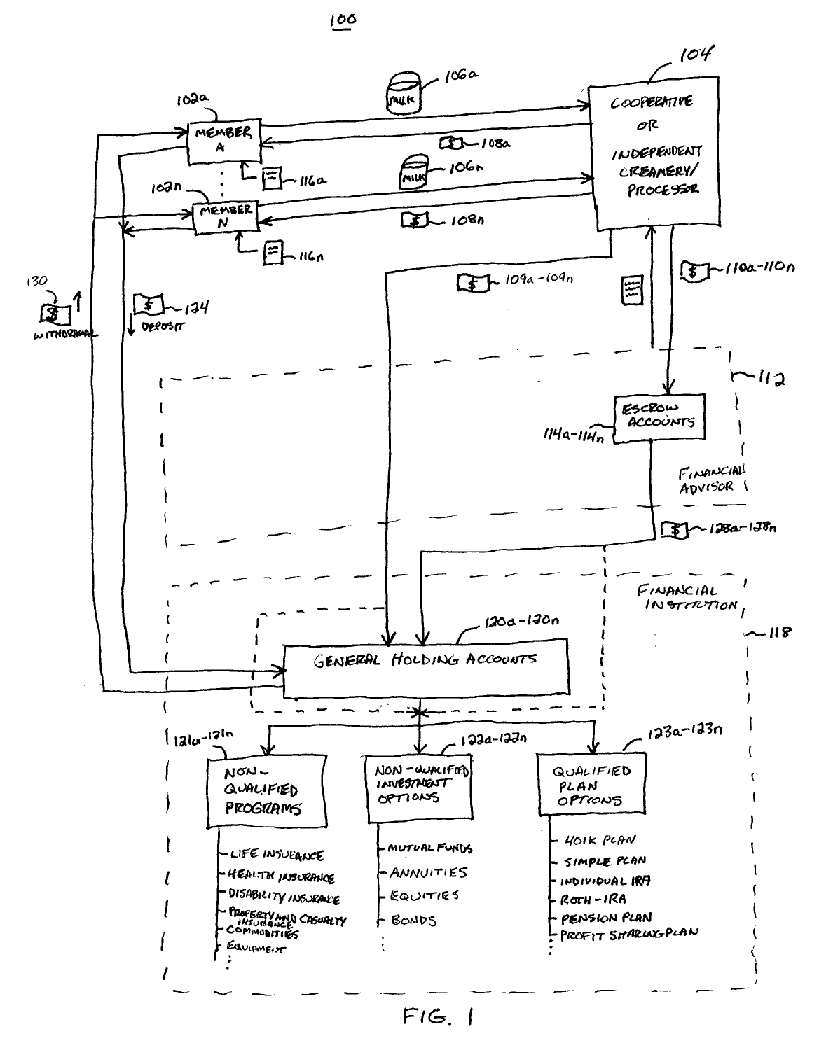

FIG. 1 is an exemplary block diagram 100 illustrating relationships between members 102a-102n (collectively 102) of a cooperative or independent creamery/processor 104 as understood in the art. In the instant example, the members 102 are dairy producers, such as, dairy farmers. It should be understood that the principles of the present invention may be applied to other types of syndicates or cooperatives 104 as broadly defined under Section 501(c) of the Code for different types of members 102.

The members 102 produce product 106a-106n (collectively 106), such as milk, that is delivered and/or sold to the cooperative 104. In exchange, the cooperative 104 pays the members 102 a product value or revenue 108a-108n (collectively 108) that is typically a function of the weight or volume of the product 106. For example, the cooperative 104 may pay the members 102 on a per one-hundred weight (CWT) basis less a “charge” as understood in the art.

According to the principles of the present invention, the cooperative 104 may offer the members 102 the ability to engage or enroll in a retirement savings plan. To fund the retirement savings plan, the cooperative 104 may allow the members 102 to establish a savings contribution or elected deferral 109. The elected deferral 109 may be a percentage of the revenues generated by the member 102. Alternatively, the elected deferral 109 may be a fixed amount. The elected deferral 109 may be made on a periodic or non-periodic basis. To encourage the members 102 to save money via the elected deferral 109, the cooperative 104 may provide a matching contribution 110a-110n (collectively 110) as a percentage of the elected deferral 109. For example, the cooperative 104 may provide a 50 percent match of the elected deferral 109 that is saved in the retirement savings plan of the member 102. Additionally, the cooperative may offer a vesting schedule (e.g., 25 percent per year) of the matching contribution 110. Because the matching contribution 110 is not being directly applied to a qualified plan, higher matching percentages and limits may be offered by the cooperative 104.

To manage the matching contribution 110, the cooperative 104 may form a relationship with a financial advisor 112. The financial advisor 112 may provide management services to escrow account(s) 114a-114n (collectively 114) for the matching contribution 110 of the cooperative 104 to be applied for the members 102. The financial advisor 112 may provide statements 116a-116n (collectively 116) of the escrow account(s) 114 to the cooperative 104 and/or directly to the members 102. The statements 116 may serve to notify the members 102 of the current balances in the escrow accounts 114, including vested and non-vested balances. Alternatively, the cooperative 104 may maintain the escrow accounts 114 and provide the financial advisor 112 with statements indicating the product 106, product revenue 108, and/or elected deferral 109 of the members 102. In response, the financial advisor 112 may determine and notify the cooperative of the balance that each member 102 has in the escrow accounts 114 containing the matching contribution 110. As understood in the art, the balances of the escrow accounts 114 may be funded or unfunded by the cooperative 104. The financial advisor 112 may also supply financial services and advice to the cooperative 104 and members 102 on a variety of other issues related to finance.

A relationship between the cooperative 104, financial advisor 112, and/or members 102 may be formed with a financial institution 118. The financial institution 118 may serve to provide investment services for the members 102. The investment services may provide general holding accounts 120a-120n (collectively 120) that operate as primary accounts for each member 102, whereby the members 102 may distribute the monies maintained therein into different sub-accounts. Three different types of sub-accounts may be offered to the members for investment purposes, including: (i) non-qualified programs 121a-121n (collectively 121), (ii) non-qualified investment options 122a-122n (collectively 122), and (iii) qualified plan options 123a-123n (collectively 123). It should be understood, however, that the non-qualified programs may be provided by institution(s) other than the financial institution 118.

Each of the different types of sub-accounts provides the member 102 with different investment options based on the financial situation of the member 102 as understood in the art. For example, if the member 102 does not show a profit for a given year, the qualified plan options 123 is not available to the member 102 so that the member 102 may contribute money to the non-qualified programs 121 or non-qualified investment options 122 for that year. In a profitable, the member 102 may elect to contribute money to the qualified plan options 123 to reduce the tax liability for that year.

The non-qualified programs 121 may include life insurance, health insurance, disability insurance, property and casualty insurance, commodities, equipment, etc. The non-qualified investment options 122 may include mutual funds, annuities, equities, and bonds, etc. The qualified plan options 123 may include a 401K plan, SIMPLE plan, individual IRA, Roth-IRA, pension plan, profit sharing plan, KEOGH plan, etc. As understood in the art, the non-qualified programs 121 and non-qualified investment options 122 are funded with post-tax monies and may or may not be tax deferred (i.e., non-tax or tax advantaged). The qualified plan options 123 may be funded by pre-tax money and be tax deferred.

The cooperative 104 may contribute the elected deferral 109 to the general holding accounts 120 for the members. Additionally and/or alternatively, the elected deferral 109 may be contributed directly to the non-qualified or qualified plans 121-123. Still yet, the members 102 may contribute after-tax money 124 directly into the general holding account 120 for investment or other purposes. The contribution of the elected deferral 109 may be performed automatically or manually and be performed on a periodic or non-periodic basis. Once the money in the escrow accounts 114 for the individual members 102 is vested, the vested matching contribution 128 is distributed to the general holding accounts 120 of the members 102. The members may thereafter invest the vested matching contribution 128 as desired. For example, if the individual members 102 show a profit for the year, then the members 102 may contribute money to the qualified plan 123 to offset tax liabilities. The matching contributions 128 may be applied to either the non-qualified 121-122 or qualified plan options 123 in either a non-profitable or profitable year, depending on how the member 102 desires to save for retirement. Again, by allowing the members 102 to direct money to the qualified plan options 123, the members 102 are able to reduce tax burdens in profitable years and gain needed revenue during non-profitable years via the vested matching contributions 110. Accordingly, the members 102 are able to withdraw the savings money 130 in the general holding accounts 120 as the savings money 130 is owned by the members. It should be understood that the money in the general holding accounts 120 are not subject to tax penalties until the money is invested in a qualified plan option 123.

TABLE 1A is an exemplary vesting schedule provided by the cooperative 104 for the members 102. As established by the cooperative 104, a vesting schedule of 25 percent per year for the matching contribution 110 is available to the members 102. It should be understood, however, that a vesting schedule may not be utilized or that other vesting schedules, including linear and non-linear, may be utilized in accordance with the principles of the present invention.

TABLE 1A
Exemplary Vesting Schedule

| | VESTING | ELECTED | ESCROW | |
|---|---|---|---|---|
| YEAR | PERCENTAGE | DEFERRAL | BALANCE | VESTED $ |
| 1 | 25% | $2000 | $1,500 | $500 |
| 2 | 25% | — | $1,000 | $1,000 |
| 3 | 25% | — | $500 | $1,500 |
| 4 | 25% | — | $0 | $2,000 |

As indicated in TABLE 1A, a 25 percent vesting schedule is applied to each year. So, for example, if a matching contribution 110 of $2,000 is applied to the escrow account 114 for the member 102, then in the first year, the member 102 has $500 of vested matching contribution 128. In year two, the member 102 has $1,000 of vested matching contribution 128 and so on. The vested matching contribution 128 may be automatically transferred from the escrow account 114 to the general holding account 120 or the member 102p may transfer the vested matching contribution 128 from the escrow account 114 into the general holding account 120. For simplicity, interest and capital gains have not been included. It should be understood that the financial advisor 112 may offer an interest rate for the money, vested or not, in escrow accounts 114 for competitive purposes. Once the money is in the general holding account 120, based on tax and operation considerations, the money may be applied to the qualified plan options 123 or non-qualified programs 121 and investment options 122.

To more specifically illustrate the principles of the present invention, TABLE 1B provides a members historical database over a period of ten years so as to illustrate a typical farming cycle in terms of revenue and profits. As understood in the art, there are many factors that can cause the members 102 (e.g., dairy farmers) not to show a profit for a given year, including: weather conditions, market competition, pricing pressures, supply costs, equipment maintenance, etc. As shown, the member 102 does not make a profit from 1992-1997. In 1998, the member 102 shows a profit of $50,000; in 1999, the member 102 shows a profit of $100,000; in 2000, the member 102 again shows a profit of $100,000. In 2001, the member 102 does not show a profit.

In 1992, the member 102 has a revenue of $40,000 and has elected a ten-percent elected deferral 109 so that $4,000 is contributed to the general holding account 120 to bring the total accumulated general holding account 120 to $14,000 (assuming that the account previously had $10,000 from 1991). The cooperative 104 applies a 50 percent match, so that the escrow account 114 is applied $2,000 for the benefit of the member 102. The total accumulation of the escrow account 114 rises to $7,000 (assuming that the previous balance was $5,000). For simplicity, no vesting schedule is applied to the matching contribution 110 in the escrow account 114 and that the matching contribution 110 is vested at the time of contribution. However, a vesting schedule may be applied by the cooperative 104 to provide incentive for the members 102 to remain in the retirement plan.

Because the member did not show a profit in 1992, the member 102 is unable to contribute money to the qualified plan options 123. The cycle of the member 102 for not showing a net profit and for making elected deferral 109 to the general holding account 120 continues through 1997, at which time the general holding account 120 has a total accumulation of $59,000, the escrow account 114 has a total accumulation of $29,500 (assuming that the member 102 does not liquidate any monies during that time period), and the total of all accounts has a balance of $88,500.

In 1998, the business conditions for the member 102 are such that the member 102 has a large revenue increase, which results in $50,000 of net profit. The member 102 is able to have an elected deferral 109 of $20,000 and have a matching contribution 110 of $10,000 into the escrow account 114. The member 102 decides to contribute $7,000 from the general holding account 120, $3,500 from the non-qualified investments and $3,500 from the escrow account 114. The non-qualified investments is reduced to $55,500 and the escrow account 114 is reduced to $26,000. It should be understood, however, that the contributions could be made in different proportions and from different sources, but that the total is generally limited based on the tax code governing the qualified plan selected. Further, interest and growth are not shown in the instant example for simplicity reasons.

In the year 1999, the business cycle continues to grow and the net profits increase to $100,000. The member is able to have an elected deferral 109 of $20,000 and a matching contribution 110 of $10,000. The member 102 may select whether, how much, and from where money is to be contributed to the various tax-qualified plans available, to reduce tax consequences. In this case, the member 102 elects to contribute $15,000 to a 401K plan in the qualified plan options 123. In performing the contribution, $10,000 is transferred from the non-qualified investments 122 and $5,000 from the escrow account 114. The total of all the accounts increases to $118,500.

The business cycle continues through year 2000 and allows the member 102 to continue contributing to the qualified plan options 123. As the business cycle slows in years 2001 and 2002, the member 102 is still able to benefit from being able to maintain the elected deferral 109 and matching contribution 110.

In summary, the example of TABLE 1B shows how the business cycle for members 102 of the cooperative 104 may be compensated utilizing the principles of the present invention. During the years 1992-1997, the member 102 is unable to show a net profit. However, because of the use of the elected deferral 109 and matching contribution 110, the member 102 is able to save money in a retirement plan. Over the next three years (i.e., years 1998-2000), the member 102 is able to accumulate money in the qualified plan options 123 by contributing money saved in the general holding account 120 during the six non-profitable years. It should be understood that the scenario of TABLE 1B is exemplary and that other scenarios and options by the member 102 and cooperative 104 may be utilized to illustrate the principles of the present invention, but that the functionality and purposes of those scenarios would be substantially the same.

TABLE 1B
Members Financial Database

| | | General Holding Account | | | | | | | |
|---|---|---|---|---|---|---|---|---|---|
| | | Non-Qualified | | Attributed to | | | | | |
| | | Investments | | Escrow | | | | | |
| Year/ | Rev. | Elected | Total | Match | Total | Amount | Qual. Plan | | Total All |
| Profit | ($000) | Deferral | Accum. | Contrib. | Accum. | Transf. | SIMPLE | 401K | Accounts |
| 1992/None | 40 | 4,000 | 14,000 | 2,000 | 7,000 | — | — | — | 21,000 |
| 1993/None | 50 | 5,000 | 19,000 | 2,500 | 9,500 | — | — | — | 28,500 |
| 1994/None | 60 | 6,000 | 25,000 | 3,000 | 12,500 | — | — | — | 37,500 |
| 1995/None | 70 | 7,000 | 32,000 | 3,500 | 16,000 | — | — | — | 43,000 |
| 1996/None | 80 | 8,000 | 40,000 | 4,000 | 20,000 | — | — | — | 60,000 |
| 1997/None | 90 | 9,000 | 49,000 | 4,500 | 24,500 | — | — | — | 73,500 |
| 1998/50K | 100 | 10,000 | 59,000 | 5,000 | 29,500 | (7,000) | 7,000 | — | 88,500 |
| | | | (3,500) | | (3,500) | | | | |
| | | | 55,500 | | 26,000 | | | | |
| 1999/100K | 200 | 20,000 | 75,000 | 10,000 | 36,000 | (15,000) | 7,000 | 15,000 | 118,500 |
| | | | (10,000) | | (5,000) | | | | |
| | | | 65,500 | | 31,000 | | | | |
| 2000/100K | 150 | 15,000 | 80,500 | 7,500 | 38,500 | (15,000) | 7,000 | 30,000 | 141,000 |
| | | | (15,000) | | | | | | |
| | | | 65,500 | | | | | | |
| 2001/None | 120 | 12,000 | | 6,000 | 44,500 | | 7,000 | 30,000 | 159,000 |
| 2002/None | 100 | 10,000 | | 5,000 | 49,500 | | 7,000 | 30,000 | 174,000 |

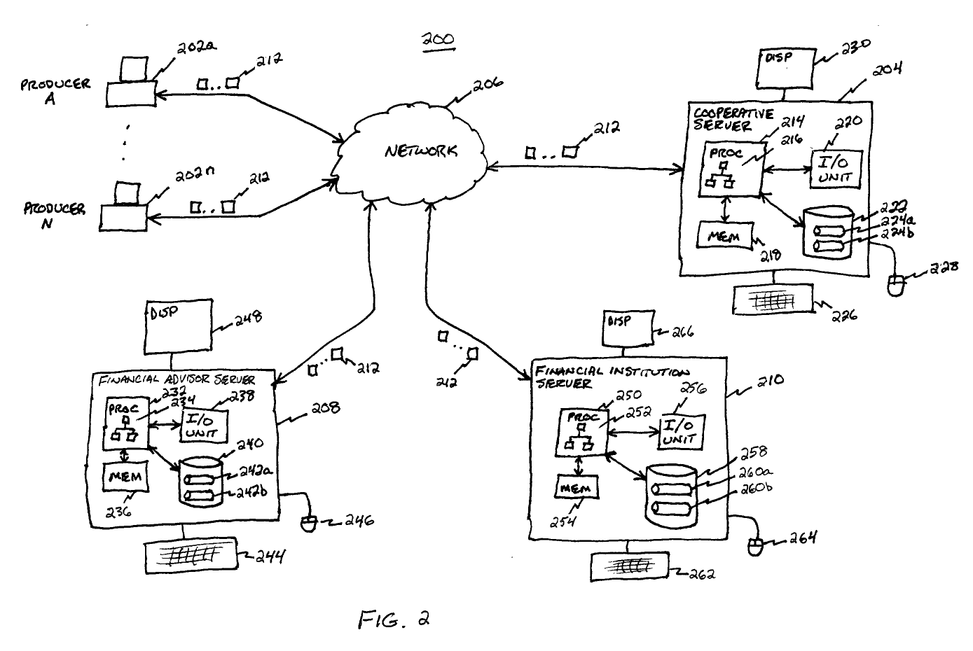

FIG. 2 is an exemplary block diagram 200 of a system for providing electronic transaction capabilities to apply the principles of the present invention for the parties of FIG. 1. As shown, each member 102 has an associated computing system 202a-202n (collectively 202). It should be understood, however, that the members 102 need not have computing system 202 to utilize the principles of the present invention. The cooperative 104 utilizes a cooperative server 204 configured to perform operations and computations associated with operating a cooperative 104. For example, the cooperative server 204 is operable to compute and manage revenues generated by the members 102 by producing the product 106. The computing systems 202 of the members 102 are able to communicate with the cooperative server 204 via a network 206. In one embodiment, the network may be the Internet. The financial advisor 112 further has a financial advisor server 208 coupled to the network 206 and configured to perform operations and computations associated with performing financial advisor services. The financial advisor server is further operable to communicate with the cooperative server 204. Additionally, the financial institution 118 utilizes a financial institution server 210 configured to perform operations and communications associated with performing financial institution operations. The financial institution server 210 is further operable to communicate with the financial advisor server 208, cooperative server 204, and computing systems 202 via the network 206. As understood in the art, communications between the various computing systems (e.g., 202 and 204) are performed using data packets 212 as understood in the art.

The cooperative server 204 includes a processor 214 operable to execute software 216 for performing calculations and management functions. The processor 214 is coupled to a memory 218 operable to store the software 216 and associated results during execution of the software 216, input/output (I/O) unit 220 operable to communicate over the network 206 and internal with components of the cooperative server 204 and storage unit 222. The storage unit 222 may be utilized to maintain one or more databases 224a and 224b (collectively 224) that includes information associated with the revenue generated by the members 102. The cooperative server 204 is further coupled to input and control devices 226 and 228, such as a keyboard and computer mouse, and display unit 230. The input and control devices 226 and 228 are utilized to control and enter information into the software 216 being executed by the processor 214.

The financial advisor server 208 may include the same or similar components as the cooperative server 204. The financial advisor server 208 includes a processor 232 and executes software 234 for managing the information provided by the cooperative server 204. The processor 232 is coupled to memory 236, I/O unit 238, and storage unit 240. The storage unit 240 may store financial advisor databases 242a and 242b (collectively 242) that includes information associated with the members 102, such as information about the matching contribution 110 being maintained in the associated escrow account 114. The financial advisor server 208 may further include input and control devices 244 and 246 and a display unit 248. The input and control device 244 and 246 may be utilized to operate the software 234 to enter and/or manage the data stored in the financial advisor databases 242. The display 248 may be utilized to visually display the information, such as account balances, being stored by the financial advisor server 208 and the escrow accounts 114.

The financial institution server 210 may further include similar components as the cooperative server 204. The financial institution server 210 includes a processor 250 that executes software 252. The software 252 may be utilized to maintain information of the general holding account(s) 120 or plans 121-123 thereof of the members 102. The processor 250 is further coupled to a memory 254, I/O unit 256, and storage unit 258. The storage unit 258 may store one or more databases 260a-260b (collectively 260). The databases 260 may be utilized to maintain the general holding accounts 120 sub-plans 121-123 thereof for the members 102. The financial institution server 210 may further be coupled to input and control devices 262 and 264, such as a keyboard and computer mouse, and display 266. Accordingly, the input and control devices 262 and 264 may be utilized to maintain and control the information stored in the databases 260.

In operation, the cooperative server 204 is operable to process revenue generated by the members 102 where the revenue generated by the members 102 may be subject to contribution and matching policies of the cooperative 104. The processor 214 may execute the software 216 to perform computations based on the revenue produced by the members 102 in accordance with the policies of the cooperative 104. As such, information indicative of a percentage of the revenue 108 (i.e., savings contribution) may be applied to records stored in the databases 224. Additionally, information indicative of a matching contribution 110 may be determined based on the percentage of the revenue computed for the members 102 to be applied to the general holding accounts 120 and stored in the databases 224.

Upon computing the revenue 108, elected deferral 109, and matching contribution 110 associated therewith, the cooperative server 204 may communicate the information with the financial advisor server 208 and financial institution server 210. The information may be communicated via the data packets 212 and provide an indication of an amount of transfer revenue (e.g., elected deferral 109 and matching contribution 110) via an electronic financial transfer to the financial advisor and institution servers 208 and 210, respectively.

The financial advisor server 208 may maintain the information for the escrow accounts 114 according to the policies of the cooperative 104 and/or the financial advisor 112. For example, the financial advisor server 208 may utilize the processor 232 to execute the software 234 in applying the vesting schedule to the matching contribution 110 stored in the escrow account 114 being maintained by the financial advisor databases 242. A financial statement 116 may be transmitted to the cooperative server 204 or the computing systems 202 of the members 102 via an electronic communication, such as an e-mail message or facsimile transmission. Alternatively, the financial advisor server 208 may generate statements on paper by a printer (not shown) and communicate the statement via a traditional mail delivery service.

Because the financial advisor server 208 is coupled to the network 206, the members 102 may access the financial advisor server 208 via the computing systems 202 to transfer money stored in the escrow accounts 114 as understood in the art. For example, the members 102 may transfer monies stored in the escrow account 114 to the general holding account 120 from the financial advisor server 208 to the financial institution server 210, respectively, by transferring information from the financial advisor databases 242 to the databases 260 for accounts associated with the members 102. Additionally, the cooperative 104 may further provide services for the members 102 by managing the general holding account 120 and sub-plans 121-122 thereof of the members 102 remotely from the cooperative server 204. Once the information is stored in the databases 260 for the members 102, the members 102 may invest in financial vehicles or otherwise as provided by the financial institution 118 or other organizations (e.g., insurance company).

TABLE 2A is an exemplary database 224 maintained by a cooperative server 204 for storing information associated with members 102 of the cooperative 104. Each member 102 may have an individual record associated therewith that identifies the member 102, last month of produce delivery, amount of produce delivered (measured in CWT), amount of revenue 108 generated by the produce delivered, amount of generated elected deferral 109, matching contribution 110, and year-to-date (YTD) matching contribution. As understood in the art, the cooperative databases 224 may be relational and that other pertinent information associated with the members 102 may be maintained.

TABLE 2A
Cooperative Database

| | | | | | Monthly | YTD |
|---|---|---|---|---|---|---|
| | | | | | Matching | Matching |
| | | Produce | | Elected | Contri- | Contri- |
| Member | Month | (CWT) | Revenue | Deferral | bution | bution |
| A | June | 4,000 | $40,000 | $4,000 | $2,000 | $12,360 |
| B | June | 2,500 | $25,000 | $2,500 | $1,250 | $8,490 |
| C | June | 2,900 | $29,000 | $2,900 | $1,450 | $9,425 |

TABLE 2B is an exemplary financial advisor database 242 maintained by the financial advisor server 208 for the members 102 of the cooperative 104. As shown, the information may include the name of the member 102, escrow account number, current matching contribution 110, current balance, and vested balance. Other relevant information may be stored in the financial advisor database 242, such as historical data, to provide additional information for the members 102 to view their account history. Additionally, information associated with the vesting schedule may be provided in the financial advisor database 242 to be utilized in generating the vested balance.

TABLE 2B
Financial Advisor Database

| | | Current | | |
|---|---|---|---|---|
| Member | Escrow | Matching | Current | Vested |
| Name | Account | Contribution | Balance | Balance |
| Member A | 1-742-342 | $2,000 | $17,426 | $6,257 |
| Member B | 2-371-894 | $1,250 | $12,322 | $4,189 |
| Member C | 8-554-188 | $1,450 | $14,708 | $4,986 |

TABLE 2C is an exemplary database 260 providing for information associated general holding account 120 and qualified plan options 123. It should be understood that additional plans, programs, accounts, etc. may be maintained. As shown, each member 102 has two related records, one to the general holding account 120 and one to an account (e.g., 401K) in the qualified plan options 123. It should be understood that the database 260 may be relational so that the accounts and balances in the general holding accounts 120 and qualified plan options 123 remain separated, yet related. The records may include name of the members 102, general holding account number, qualified account number, current contribution, and current balance. Accordingly, associated with each member 102, historical information may be maintained as understood in the art. For example, social security number, enrollment date, gross CWT between certain dates, contribution per CWT between the dates, qualifying and non-qualifying monthly and annual contributions, and matching monthly and annual contributions may be provided.

TABLE 2C
Financial Institution Database

| | General | | | |
|---|---|---|---|---|
| | Holding | Qualified | Current | Current |
| Member Name | Account | Account | Contribution | Balance |
| Member A | 7178274 | — | $1,500 | $57,183 |
| Member A | — | 7178274A | $500 | $27,218 |
| Member B | 1837428 | — | $1,250 | $83,284 |
| Member B | — | 1837428A | $640 | $38,847 |
| Member C | 8274822 | — | $1,375 | $39,204 |
| Member C | — | 8274822A | $350 | $12,374 |

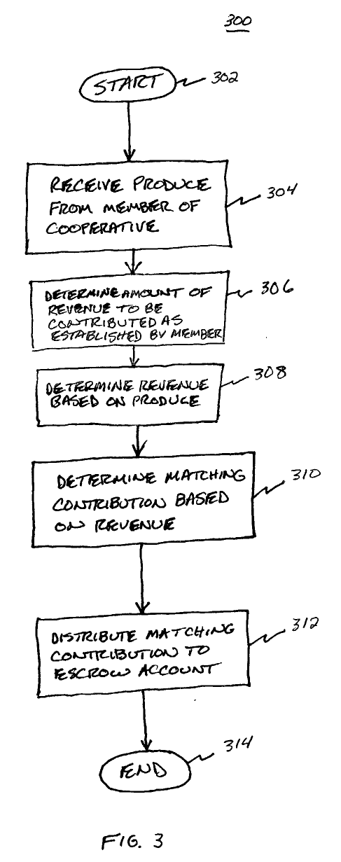

FIG. 3 is an exemplary flow diagram 300 according to the principles of the present invention of a method for providing a retirement savings plan for members 102 of the produce from a member 102 of the cooperative 104 is received. The process starts at step 302. At step 304, product 106 is received from a member 102 of the cooperative 104. At step 306, the amount of revenue 108 to be contributed as established is determined. At step 308, based on the amount of produce 106 received from the member 102, revenue 108 is determined. A matching contribution 110 based on the revenue 108 is further determined at step 310. If the matching contribution 110 is based on the elected deferral 109, then it should be understood that the matching contribution 110 is still based on the revenue 108 produced, but in a derivative manner. At step 312, the matching contribution 110 is distributed to the escrow account 114. A vesting schedule may be utilized for maintaining the matching contribution 110 in the escrow account 114. The process ends at step 314.

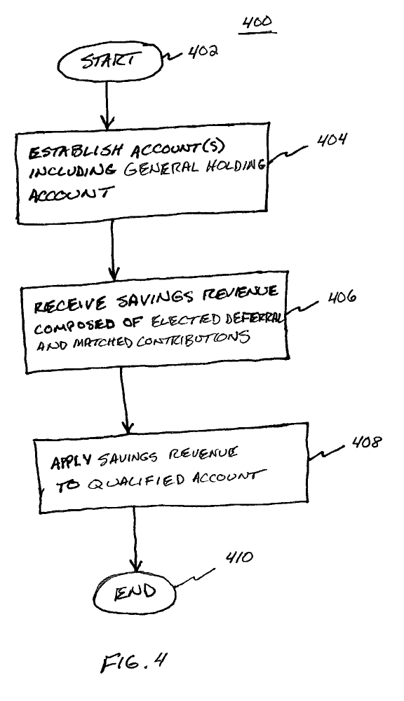

FIG. 4 is an exemplary flow diagram 400 that provides for a retirement savings plan by a financial institution 118 for a member 102 of a cooperative 104 according to FIG. 1A. The process starts at step 402. At step 404, one or more accounts are established for the member 102, where at least one of the accounts is an account of the qualified plan options 123. Savings revenue, composed of matching contribution 110 and elected deferral is received at step 406. At step 408, the savings revenue is applied to the qualified account. The process ends at step 410. Additionally, the process may include receiving the savings revenue and applying the savings revenue to the general holding account 120 for the member 102 of the cooperative 104. The savings revenue may further be transferred from the general holding account 120 to an account in the qualified plan options 123. The matching contribution 110 may be established by the cooperative and based on a percentage of the revenue generated by the member 102. Investment options for the elected deferral 109 and matching contribution 110 applied to the general holding account 120 may be provided to the member 102 to make informed investment decisions.

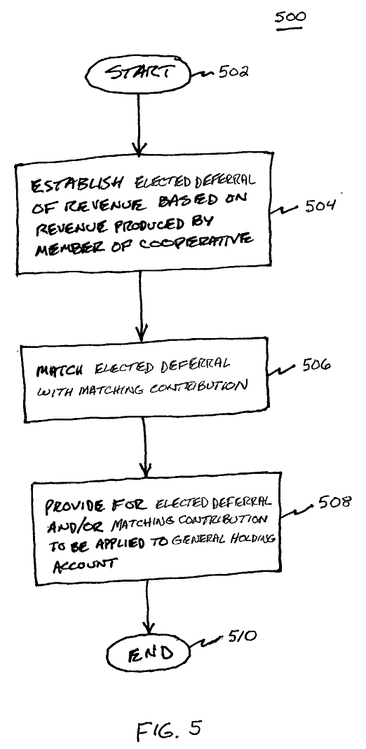

FIG. 5 is an exemplary flow diagram 500 for providing a retirement savings plan to members 102 of the cooperative 104. The process starts at step 502. At step 504, withholding of revenue 108 or elected deferral 109 based on revenue 108 produced by the member 102 of the cooperative 104 is established. The elected deferral 109 may be formed as predetermined by the member 102 based on a percentage of the revenue 108 and/or as a function of the amount of product or produce 106 delivered by the member 102 to the cooperative 104. At step 506, a matching contribution 110 is generated. The matching contribution 110 may be computed as a function (e.g., percentage) of the revenue 108 generated by the member 102. At step 508, the elected deferral 109 and/or matching contribution 110 to be applied to a general holding account 120 is provided. It should be understood that the elected deferral 109 and/or matching contribution 110 may alternatively be applied directly to the non-qualified programs 121, non-qualified investment options 122, and/or qualified plan options 123 without first being applied to the general holding account 120. In providing for the elected deferral 109 and/or matching contribution 110 to be applied to the general holding account 120, the cooperative 104 may form a financial relationship with the cooperative 104 and/or financial advisor 112. Additionally, the cooperative 104 may apply the matching contribution 110 to an escrow account 114, where the matching contribution 110 applied to the escrow account 114 may be maintained by a financial advisor 112 and be managed according to a vesting schedule as established by the cooperative 104. The process ends at step 510.

The previous description is of a preferred embodiment for implementing the principles of the present invention, and the scope of the invention should not necessarily be limited by this description. The scope of the present invention is instead defined by the following claims.

What is claimed is:

1. A method for providing a retirement savings plan for members of a cooperative, said method comprising:
receiving product from a member of the cooperative;
setting an elected deferral to be withheld by the cooperative for the member;
withholding the elected deferral from revenue generated by the product received from the member;
determining profitability of the member for the current year; and
based on the profitability of the member for the current year, contributing the elected deferral to a qualified plan associated with the member.

2. The method according to claim 1, further comprising:
determining a matching contribution based on the elected deferral; and
applying the matching contribution to an escrow account associated with the member.

3. The method according to claim 2, further comprising establishing a vesting schedule for the matching contribution applied to the escrow account.

4. The method according to claim 3, wherein said establishing of the vesting schedule is performed by the cooperative.

5. The method according to claim 1, wherein said determining profitability of the member is based on the tax code.

6. The method according to claim 1, wherein said setting the elected deferral includes setting a percentage value.

7. The method according to claim 1, wherein the product is milk.

8. The method according to claim 1, wherein the cooperative is a dairy cooperative.

9. The method according to claim 1, wherein said withholding is performed automatically.

10. A method for providing a retirement savings plan for members of a dairy cooperative, said method comprising:
receiving produce from a member of the cooperative;
determining a revenue based on the produce received from the member;
determining a matching contribution based on the determined revenue; and
distributing the matching contribution to an escrow account associated with the member.

11. The method according to claim 10, wherein said determining the matching contribution includes computing a percentage of the determined revenue.

12. The method according to claim 10, wherein the produce is milk.

13. The method according to claim 10, further comprising forming a vesting schedule by which the escrow account is to maintain the matching contribution.

14. The method according to claim 13, wherein the vesting schedule is predetermined by the cooperative.

15. The method according to claim 10, further comprising distributing the revenue to at least one of the following: the member and a general holding account.

16. A system for providing a retirement savings plan for members of a dairy cooperative, said system comprising:
means for receiving produce from a member of the cooperative;
means for determining a revenue based on the produce received from the member;
means for determining a matching contribution based on the determined revenue; and
means for distributing the matching contribution to an escrow account associated with the member.

17. A method for providing a retirement savings plan by a financial institution for a member of a cooperative, said method comprising:
establishing at least one account for the member of the cooperative, at least one account including a qualified account;
receiving elected deferral matching revenue based on production revenue of the member; and
applying the elected deferral to a qualified plan based on profitability of the member for the current year.

18. The method according to claim 17, further comprising:
receiving the elected deferral; and
applying the elected deferral to a general holding account for the member of the cooperative.

19. The method according to claim 17, wherein the cooperative is a dairy cooperative.

20. The method according to claim 17, further comprising receiving a matched contribution from the cooperative, the matched contribution being based on the elected deferral of the member.

21. The method according to claim 17, further comprising providing a plurality of investment options for the elected deferral.

22. The method according to claim 21, wherein the investment options include at least one of the following: non-qualified programs, non-qualified investment options, operational equipment, and qualified plan options.

23. A system for providing a retirement savings plan by a financial institution for a member of a cooperative, said system comprising:
means for establishing at least one account for the member of the cooperative, at least one account including a qualified account;
means for receiving elected deferral matching revenue based on production revenue of the member; and
means for applying the elected deferral to a qualified plan based on profitability of the member for the current year.

24. The system according to claim 23, further comprising:
means for receiving the elected deferral; and
means for applying the elected deferral to a general holding account for the member of the cooperative.

25. The system according to claim 23, further comprising means for receiving a matched contribution from the cooperative, the matched contribution being based on the elected deferral of the member.

26. A system for providing a savings plan for members of a cooperative, said system comprising:
a computing system including a processor coupled to a storage unit having a database stored thereon, the database including (i) an identifier indicative of a member and (ii) data associated with the members the data being representative of a matching contribution based on revenue produced by the member of the cooperative.

27. The system according to claim 26, wherein the database further includes data indicative of a vesting schedule for vesting the matching contribution for the member of the cooperative.

28. The system according to claim 26, wherein the database further includes data indicative of at least one of qualified and non-qualified investments of the member.

29. The system according to claim 26, wherein the database further includes data indicative of an amount of product delivered by the member to the cooperative.

30. The system according to claim 26, wherein the processor is operable to compute the matching contribution for the member.

31. A method for providing a retirement savings plan to members of a cooperative, said method comprising:
establishing an elected deferral based on revenue produced by production of a product by a member of the cooperative;
determining a matching contribution based on the elected deferral; and
providing for at least one of the elected deferral and matching contribution to be applied to a qualified plan based on profitability of the member for a current year.

32. The method according to claim 31, further comprising applying the matching contribution to an escrow account.

33. The method according to claim 31, further comprising applying the matching contribution to a general holding account.

34. The method according to claim 31, further comprising establishing a vesting schedule for the matching contribution.

35. The method according to claim 31, further comprising vesting a percentage of the matching contribution over a predetermined time duration.

36. The method according to claim 31, wherein said determining of the matching contribution includes computing a percentage of the revenue produced from the production of the product by the member.

37. The method according to claim 31, wherein the matching contribution is a percentage of the elected deferral.

38. The method according to claim 31, wherein said providing includes establishing a financial relationship with a financial institution to manage the qualified plan.

39. A system for providing a retirement savings plan to members of a cooperative, said method comprising:
means for establishing an elected deferral based on revenue produced by production of a product by a member of the cooperative;
means for determining a matching contribution based on the elected deferral; and
means for providing for at least one of the elected deferral and matching contribution to be applied to a qualified plan based on profitability of the member for a current year.

40. The system according to claim 39, further comprising means for applying the matching contribution to an escrow account.

41. The system according to claim 39, further comprising means for applying the matching contribution to a general holding account.

42. The system according to claim 39, further comprising means for establishing a vesting schedule for the matching contribution.

43. A method for allocating a portion of revenue produced from a business operated by a member of a syndicate as a member contribution, said method comprising:
depositing the member contribution in a general holding account for a year in which the business is not profitable;
computing a percentage of the member contribution in an escrow account as a matched contribution made by the syndicate on behalf of the member for the year in which the business is not profitable; and
transferring at least a portion of the balance from at least one of the general holding account and the escrow account to a qualified account for a year in which the business is profitable and in an amount less than the profit for that year.

44. The method according to claim 43, wherein the syndicate is a cooperative.

45. The method according to claim 44, wherein the cooperative is a dairy cooperative.

46. The method according to claim 43, wherein the business is a dairy farm.

47. The method according to claim 43, wherein said depositing of the member contribution in a general holding account is performed each year the business is not profitable.

48. The method according to claim 43, further comprising depositing the matched contribution into the escrow account for each year in which the business is not profitable.

49. The method according to claim 43, further comprising receiving a request from the member for said transferring of at least a portion of the balance of the general holding account for a profitable year.

50. The method according to claim 43, further comprising applying a vesting schedule to the contributions deposited to the escrow account.

51. A system for allocating a portion of revenue produced from a business operated by a member of a syndicate as a member contribution, said system comprising:
means for depositing the member contribution in a general holding account for a year in which the business is not profitable;
means for computing a percentage of the member contribution in an escrow account as a matched contribution made by the syndicate on behalf of the member for the year in which the business is not profitable; and
means for transferring at least a portion of the balance from at least one of the general holding account and the escrow account to a qualified account for a year in which the business is profitable and in an amount less than the profit for that year.

52. The system according to claim 51, further comprising means for receiving a request from the member for said transferring of at least a portion of the balance of the general holding account for a profitable year.

53. The method according to claim 51, further comprising means for applying a vesting schedule to the contributions deposited to the escrow account.
